(19) United States
(12) Patent Application Publication
(10) Pub. No.: US 2021/0231980 A1
(43) Pub. Date: Jul. 29, 2021

(54) Anti-Fog Eyewear

(71) Applicant: Cody Larson, New Rockford, ND (US)

(72) Inventor: Cody Larson, New Rockford, ND (US)

(21) Appl. No.: 17/159,009

(22) Filed: Jan. 26, 2021

Related U.S. Application Data
(60) Provisional application No. 62/967,442, filed on Jan. 29, 2020.

(51) Int. Cl. G02C 11/08; G02C 5/00

(52) U.S. Cl. CPC G02C 11/08; G02C 5/001

(57) ABSTRACT

An article of manufacture for anti-fog eyewear with active elements is disclosed. The anti-fog eyewear includes an eyeglass frame, a pair of temple arms coupled to opposite ends of the eyeglass frame, a pair of anti-fog lens elements coupled within the eyeglass frame, a pair of power cells, a pair of heat-trace cable, and a charging port. Each of the two power cells coupled to one of the pair of temple arms. Each of the heat trace cables being coupled about one of the two anti-fog lenses and is electrically coupled to one of the two power cells.

### CROSS-REFERENCE TO RELATED APPLICATION

This application claims priority to U.S. Provisional Patent Application No. 62/967,442, titled “Anti-Fog Eyewear” and filed on Jan. 29, 2020. The entire application is incorporated herein by reference in its entirety

### TECHNICAL FIELD

This application relates in general to an article of manufacture for providing all weather visual aids, and more specifically, to an article of manufacture providing anti-fog eyewear with active elements.

### BACKGROUND

A common and well-known problem in eyewear is eyewear fogging. This is a particularly common occurrence in cold temperatures, and even more so, in subzero temperatures.

Eyewear fogging can occur, for example, when water vapor from one's breath comes into contact with cold lenses of eyewear including glasses or safety glasses causing condensation to form on the lens. Various antifogging coatings are available to combat this problem; however, they generally are not effective under real-world conditions. Accordingly, a need exists for better antifogging solutions for eyewear including safety glasses. Improved eyewear including safety glasses would be important in many industries including construction, law enforcement, military, and oil refinery, and for recreational use as well.

Therefore, a need exists for an article of manufacture providing anti-fog eyewear with active elements. The present invention attempts to address the limitations and deficiencies in prior solutions according to the principles and example embodiments disclosed herein.

### SUMMARY

In accordance with the present invention, the above and other problems are solved by providing an article of manufacture providing anti-fog eyewear with active elements to the principles and example embodiments disclosed herein.

In one embodiment, the present invention is an article of manufacture providing anti-fog eyewear with active elements. The anti-fog eyewear includes an eyeglass frame, a pair of temple arms coupled to opposite ends of the eyeglass frame, a pair of anti-fog lens elements coupled within the eyeglass frame, a pair of power cells, a pair of heat-trace cable, and a charging port. Each of the two power cells is coupled to one of the pair of temple arms. Each of the heat trace cables is coupled about one of the two anti-fog lenses and is electrically coupled to one of the two power cells.

In another aspect of the present disclosure, the anti-fog lens are grooved to dissipate heat.

In another aspect of the present disclosure, the anti-fog lenses meet or exceed the ANSI Z87.1 design standard.

In another aspect of the present disclosure, the eyewear further includes an on-off control coupled to each of the power cell and heat-trace cable circuits to enable and disable the operation of the heat-trace cables.

In another aspect of the present disclosure, the on-off control comprises a pair of switches each of which controls one of the power cell and heat-trace cable circuits.

In another aspect of the present disclosure, the eyewear further includes a pair of charging ports, each of the two charging ports separately charges one of the two power cells

In another aspect of the present disclosure, the charging ports comprise a USB-C port, a mini-USB port, and a micro-USB port.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example computing system using an article of manufacture providing anti-fog eyewear with active elements according to the present invention.

FIG. 2 illustrates an example embodiment of an article of manufacture providing anti-fog eyewear with active elements according to the present invention.

FIG. 3 illustrates top perspective view of an article of manufacture for providing anti-fog eyewear with active elements according to the present invention.

FIG. 4 illustrates another example embodiment of an article of manufacture for providing anti-fog eyewear with active elements insert according to the present invention.

FIG. 5 illustrates another example embodiment of an article of manufacture for providing anti-fog eyewear with a charging case insert according to the present invention

FIG. 6 illustrates yet circuit diagrams for the charging case and anti-fog eyewear according to the present invention.

### DETAILED DESCRIPTION

This application relates in general to an article of manufacture providing all weather visual aids., and more specifically, to an article of manufacture providing anti-fog eyewear with active elements according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “user” refer to an entity, e.g. a human, using anti-fog eyewear with active elements associated with the invention. The term user herein refers to one or more users.

The term “invention” or “present invention” refers to the invention being applied for via the patent application with the title “Anti-Fog Eyewear.” Invention may be used interchangeably with glasses.

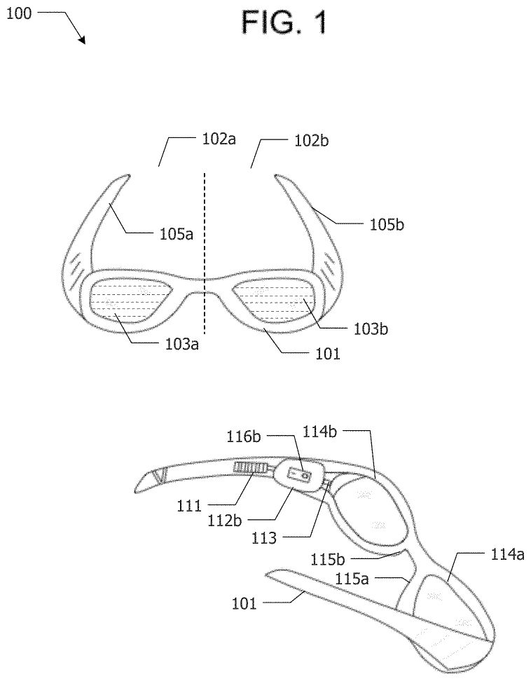

In general, the present disclosure relates to an article of manufacture providing anti-fog eyewear with active elements. To better understand the present invention, FIG. 1 illustrates an example embodiment of an article of manufacture providing anti-fog eyewear with active elements according to the present invention. The anti-fog eyewear 101 solves the problem of eyewear fogging. In FIG. 1, the eyewear 100 comprise a zone 1 102a and a zone 2 102b. The eyewear 100 shown in this example also includes an illuminated battery indicator source 111, a charging port 113, heating element 117 and a heat trace cable 114b. As noted in the Figure, the outside diameter of the lenses 103a-b may be grooved to seat the heat trace cable 114a-b. The eyewear further includes nose pads 115a-b. The heat trace cable 114a-b is sufficient to keep the glasses at any temperature warm enough to prevent fogging, e.g., about 40° F. to about 80° F. In this example, the glasses 100 are kept at a temperature of around 65° F.

Fog resistant glasses 100 and safety glasses are disclosed that provide clear visibility by maintaining a constant temperature of around 65° F. Power may be provided by power cells 112a-b, in one embodiment, two power cells 112a-b that provide power to each of the two lenses 103a-b. The power cells 112a-b may provide power to different lens zones, e.g. left\right zones 102a-b.

The power cells 112a-b are capable of providing sufficient energy to a self-regulating heat-trace cable 114a-b. The heat-trace cable 114a-b may be capable of warming a lens to approximately 65-75° F. which will prevent condensation from forming and therefore fogging of the lens. Each power cell 112a-b may be equipped with an on-off control 116a-b. The on-off control 116a-b may be inward facing in one embodiment. A power cell 112a-b, heat-trace cable 114a-b, and on-off control 116a-b may be located on each of the two temple arms 105a-b of the eyewear 100. In alternate embodiments (not shown) a single on-off control 116 that separately engages each of the power cell 112a-b/heat-trace cable 114a-b circuits may be used in place of multiple on-off controls 116a-b.

A charging port 113a-b for each power cell 112a-b may also be provided by a USB port 113. The USB port 113 may be, for example, a USB-C port or a micro/mini-USB port, and may be located near a hinge assembly of each zone. This is only one example and other placements are possible depending on the characteristics of the eyewear or eyeglasses and power cells.

The power cells 112a-b may be charged separately. In one embodiment, a fully charged cell 112a-b may be capable of powering a heat trace cable 114a-b for up to five hours. This result may depend, for example, on the environment in which that the glasses 101 are being worn. In one embodiment, charging ports 113a-b for the power cells 112a-b may be provided to be accessible when the eyewear 101 are in a stored position. The charging ports 113a-b may be protected from debris and dirt during use. In alternate embodiments, a single charging port 113 may be used to recharge both of the power cells 112a-b simultaneously.

The power cells 112a-b may be made from lithium-ion batteries. Lithium-ion batteries commonly require a constant current charging circuit or a constant voltage type of charging algorithm. The heat trace cable should be self-regulating. The heat trace cables 114a-b may be extended to wrap around the power cell battery as well as the lens to ensure that extreme cold weather does not deplete the battery charge.

The frames 101 of the eyewear 100 as well as the temple arms 105a-b, in one embodiment, may be made of a lightweight material including, for example, titanium which can offset any extra weight from the power cells and heat-trace cable. High-impact polycarbonate lenses 103a-b may be grooved to seat the heat-trace cable 114a-b and may be ANSI Z87.1 rated. A single groove around the outside diameter of each lens 103a-b. An additional groove may be located the face of each lens to provide heating to the center of lens 103a-b.

The eyewear 100 may be designed for recreational use as well as for safety glasses. Safety glasses are a preferred embodiment since the features of the invention would be particularly advantageous for work/safety glasses.

As noted in the Figures other embodiments may include safety features to protect the power cell 112a-b while being used in a potentially hazardous atmosphere or environment.

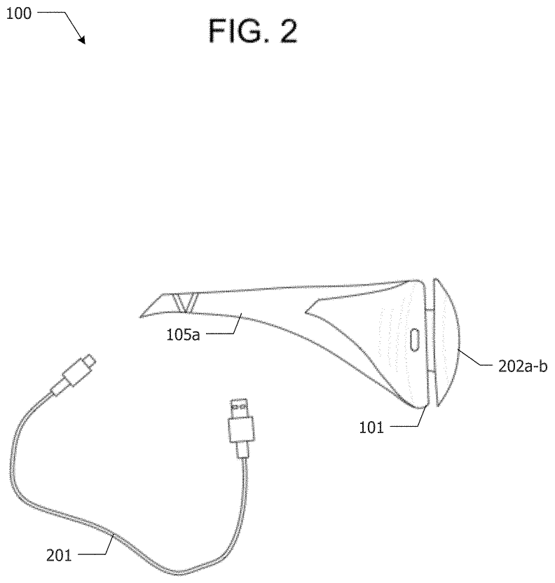

FIG. 2 illustrates another view of an article of manufacture providing anti-fog eyewear with active elements according to the present invention. The eyewear 100 is shown with a USB charging cable 201. The eyewear lenses 202a-b are shown having safety glass properties. FIG. 2 shows an example of a lightweight titanium frame, 101 high impact polycarbonate lenses 202a-b, and a USB port 203. In this example, the USB port may be configured to only be accessible while in a stored position to protect from dirt and debris.

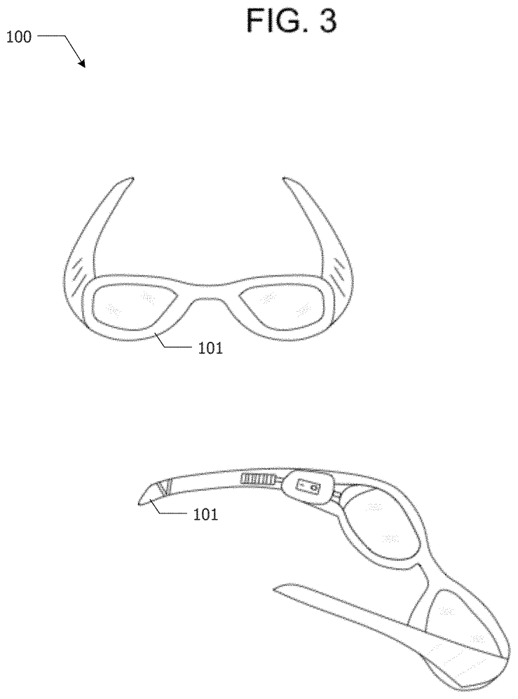

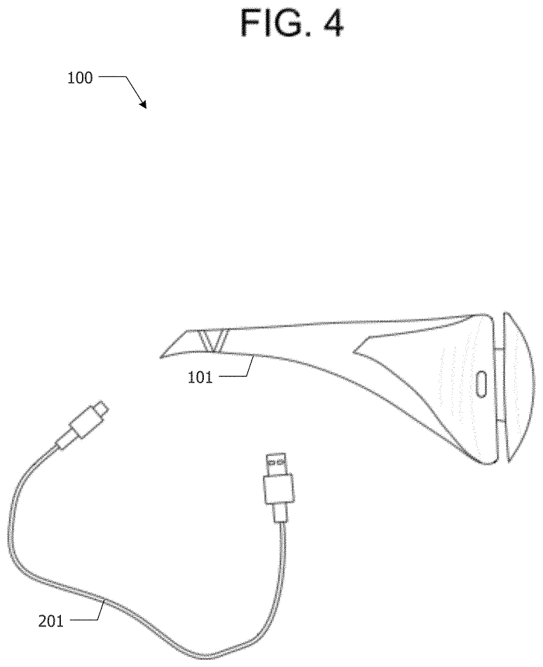

FIG. 3 shows an embodiment of safety glasses of the present disclosure. FIG. 4 shows a side view of an embodiment of the eyewear 101 along with a charging cable 201. In these embodiments, the lenses are manufactured to provide safety glasses for eye protection of workers in various work environment. The addition of the anti-fog heating elements disclosed herein adds an additional layer of safety as the worker's vision will not be impaired by lenses that fog in changing temperature environments.

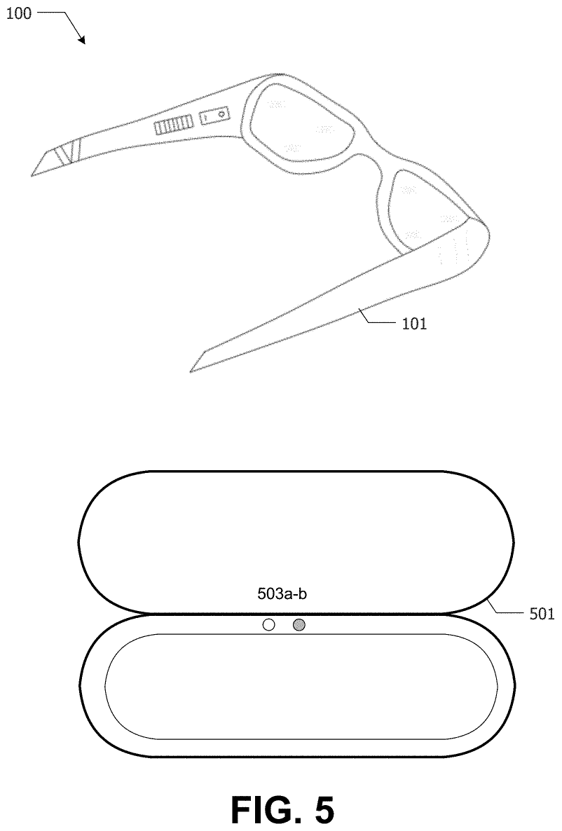

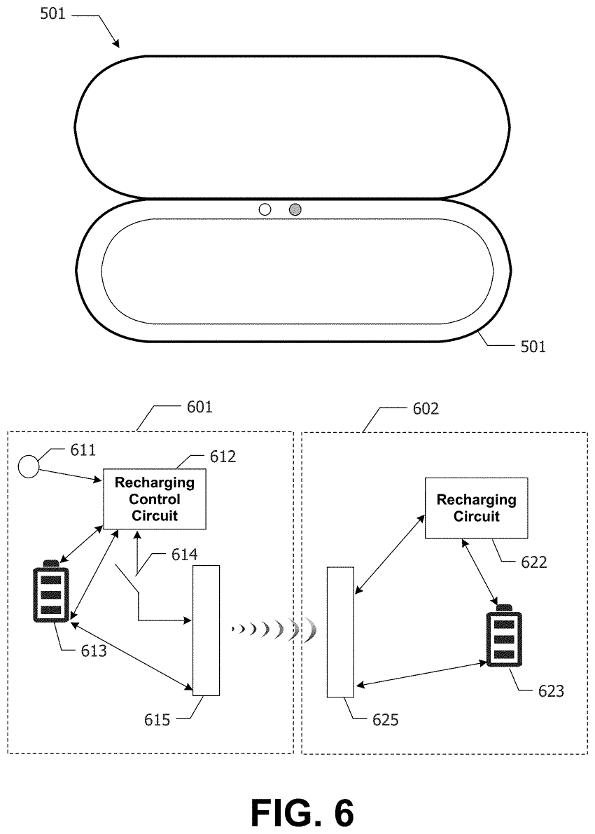

FIG. 5 illustrates another example embodiment of an article of manufacture for providing anti-fog eyewear with a charging case insert according to the present invention. The eyewear 100 of FIG. 5 shows another embodiment of eyewear 100, in this embodiment, the heat-trace cables 114a-b are embedded within the frame 101 and temple arms 105a-b. A charging case 501 is shown to provide an eyeglass case to enclose the eyewear 101 therein. The charging case 501 contains a battery and inductive charging circuit that magnetically charges the eyewear battery 623within the eyewear 101 using inductive charging circuitry conforming to the Qi and/or the PMA standards. When the case 501 is closed, the charging element of the case engages to inductively recharge the batteries within the eyewear. Additional details are described below in reference to FIG. 6.

FIG. 6 illustrates yet circuit diagrams for the charging case and anti-fog eyewear according to the present invention. The charging case 501 contains a charging circuit 601 that is configured to inductively recharge the eyewear battery 623 within the eyewear charging circuit 602. The charging case circuit 601 includes an external connector 611, a recharging control circuit 612, a case battery 613, a switch 614, and inductive coils 615. The external connector 611 provides the charging case 501 with a power input connector for providing an external power source to recharge the batteries within the system. The external connector 611 may consist of a USB connector used to provide power to portable electronic devices. The external connector 611 may be a USB-C type, a mini-USB type, and a micro-USB type connector that provides input voltage to the charging case circuit 601.

The recharging control circuit 612 operates to recharge the battery 623 within the eyewear 101. The recharging control circuit 612 detect the presence of an external power source connected to the external connector 611 and supplies the power to the remaining components in the circuitry 601-602. The recharging control circuit 612 monitors a charge level within the case battery 613 and provides electrical charge from the external power source to recharge the case battery 613 when it is not fully charge. The recharging control circuit 612 operates to provide and disconnect the external power from the case battery 613 to extend a useful lifetime for the case battery.

The recharging control circuit 612 also detects when the charging case is closed using electrical connections 305-b within the charging case 501. The recharging control circuit 612 provides electrical power to the inductive coils 615 from the external connector 611 when the external power source is connected, and the case is closed. The recharging control circuit 612 provides electrical power to the inductive coils 615 from the case battery 613 when the external power source is not connected to the external connector 611. The recharging control circuit 612 closes the switch 614 when power is to be provided to the inductive coils 615.

The inductive coils 615 receive electrical charge from the case battery 613 to magnetically induce charging within the eyewear battery 623 using the eyewear inductive coils 625. The pair of inductive coils 615, 625 magnetically cause electrical charge within the case battery 623 to move from its cathode to its anode as the battery 623 is recharged.

The eyewear charging circuit 602 includes the eyewear battery 623 as discussed above and the eyewear recharging circuit 622. The eyewear recharging circuit 622 monitors a charge level within the eyewear battery 623 and provides electrical charge from the inductive coils 625 to recharge the eyewear battery 623 when it is not fully charge. The eyewear recharging circuit 622 operates to provide and disconnect the case provided induced power from the inductive coils 625 to extend a useful lifetime for the eyewear battery 623.

While this disclosure includes specific examples, it will be apparent after an understanding of the disclosure of this application has been attained that various changes in form and details may be made in these examples without departing from the spirit and scope of the claims and their equivalents. Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture for providing anti-fog eyewear with active elements, the article comprises:
an eyeglass frame;
a pair of temple arms coupled to opposite ends of the eyeglass frame;
a pair of anti-fog lens elements coupled within the eyeglass frame;
a pair of power cells, each of the two power cells coupled to one of the pair of temple arms;
a pair of heat-trace cable, each of the heat trace cables being coupled about one of the two anti-fog lenses and is electrically coupled to one of the two power cells; and
a charging port.

2. The article of manufacture according to claim 1, wherein the anti-fog lens are grooved to dissipate heat.

3. The article of manufacture according to claim 2, wherein the anti-fog lenses meet or exceed the ANSI Z87.1 design standard.

4. The article of manufacture according to claim 1, wherein the article further comprises:
an on-off control coupled to each of the power cell and heat-trace cable circuits to enable and disable the operation of the heat-trace cables.

5. The article of manufacture according to claim 4, wherein the on-off control comprises a pair of switches each of which controls one of the power cell and heat-trace cable circuits.

6. The article of manufacture according to claim 4, wherein the article further comprises:
a pair of charging ports, each of the two charging ports separately charges one of the two power cells.

7. The article of manufacture according to claim 6, wherein the charging ports comprise a USB-C port, a mini-USB port, and a micro-USB port.
